(19) United States
(12) Patent Application Publication
(10) Pub. No.: US 2003/0201979 A1
(43) Pub. Date: Oct. 30, 2003

(54) Control wheel with tactile feedback

(75) Inventors: David A. Sandage, Forest Grove, OR (US); Octavio Todd Garcia, Tigard, OR (US)

Correspondence Address: MARGER JOHSON & McCOLLOM, P.C., 1030 S.W. Morrison Street, Portland, OR, 97205, US

(73) Assignee: Intel Corporation, Santa Clara, CA

(21) Appl. No.: 10/136,016

(22) Filed: Apr. 29, 2002

(51) Int. Cl. G09G 5/08

(52) U.S. Cl. 345/164

(57) ABSTRACT

An input device provides tactile feedback to its user. The input device includes a rotatable control wheel that provides an input signal to a host device, and further includes a control wheel limiter structured to, in response to a received position signal, limit rotatability of the control wheel.

### BACKGROUND OF THE INVENTION

1. Technical Field

The present invention is related to the field of input devices for viewing an electronic document, and more specifically to an input device having a scroll wheel that provides tactile feedback.

2. Background of the Invention

Web pages and other electronic documents frequently cannot be displayed in their entirety in a viewing window of an electronic host device. This is particularly true with the increasing use of handheld devices and cellular telephones for internet browsing and text viewing, which have small viewing screens.

For typical documents whose length exceeds the length of the host viewing window, a user usually must scroll down to view the bottom portion of the document. The user must then scroll up to again reach the top. Scroll wheels, coupled to either a computer mouse or the host device, are commonly used to move the document up or down within the viewing window. A scroll wheel typically is a small wheel provided on the mouse or host device and rotatable by the user's finger to control a scrolling function. Most commonly, a portion of the wheel protrudes out of a surface of the device, so that the tip of the wheel is exposed and movable with the user's finger.

A well-known computer mouse and keyboard are shown (FIGS. 1-2, respectively), each having integrated therein a scroll wheel. The mouse 10 includes a mouse body 12 having a holel4, through which a wheel 16 protrudes. The wheel typically is configured, e.g., includes a knurled surface 18, to be easily rotated by a user's finger while holding the body of the mouse or with minimal hand movement on the keyboard. The keyboard 20 of the prior art has a body 22 also including a hole 24 through which the scroll wheel 16 protrudes.

Existing mouse wheels generally have a single frictional feel to them so that they stop rotating when not urged by a user. For mouse wheels having physical detents, the detents usually are uniformly spaced apart and have a fixed tactile response.

Electronic document positioning conventionally is shown by the position of a sliding scroll tab or elevator bar, typically on the right margin of a viewing window. It is often difficult for the viewer to determine from this visual cue when the top or bottom of the document has been reached. Again, this problem is especially prevalent with palm-top or other small devices, owing to their smaller screens and generally lower resolutions. Embodiments of the invention address these and other limitations of the prior art.

### BRIEF DESCRIPTION OF THE DRAWINGS

FIGS. 1-2 are perspective diagrams of devices of the prior art, showing a computer mouse and keyboard, respectively, with an integrated control wheel.

FIG. 3 is a cross-sectional side view of an input device as described herein.

FIG. 4 is a cross-sectional side view of another embodiment of the present input device.

FIG. 5 is a cross-sectional side view of a second alternative dual-solenoid control wheel limiter.

FIGS. 6-7 are cross-sectional side and front views, respectively, of a third alternative embodiment input device.

FIG. 8 is a cross-sectional side view of a third alternative embodiment of the control wheel disclosed herein, mounted on a panel face.

### DETAILED DESCRIPTION OF THE PREFERRED EMBODIMENT(S)

A control wheel is disclosed herein that provides tactile feedback to a user. The control wheel can be incorporated into a computer mouse, a keyboard, a panel (e.g., a palm-top electronic device surface or a cellular telephone face). In other embodiments, the control wheel can be a knob-like structure, for example, a tuner knob on a radio front panel.

A cross-sectional side view of one embodiment (computer mouse) of an input device is shown in FIG. 3. The mouse 30 includes a mouse frame 32 having a control wheel aperture 34. A rotatable control wheel 36 is mounted on an axle 38 and protrudes sufficiently through the control wheel aperture 34 to allow it to be rotated by a user.

The control wheel 36 is structured to provide an input signal to a host device. Rotating the control wheel causes the host device to scroll a document within a display window.

A control wheel limiter, such as solenoid 40, is further mounted within the mouse frame. The control wheel limiter is structured to, in response to a position signal from a host device, limit rotatability of the control wheel. The position signal is described in more detail below.

Limitation of control wheel rotatability is achieved by mechanically or frictionally engaging the control wheel. In the embodiment of FIG. 3, the solenoid 40 is shown in an inactive state wherein the control wheel can be freely rotated by the user, although the standard frictional resistance of a typical scroll wheel may still be felt.

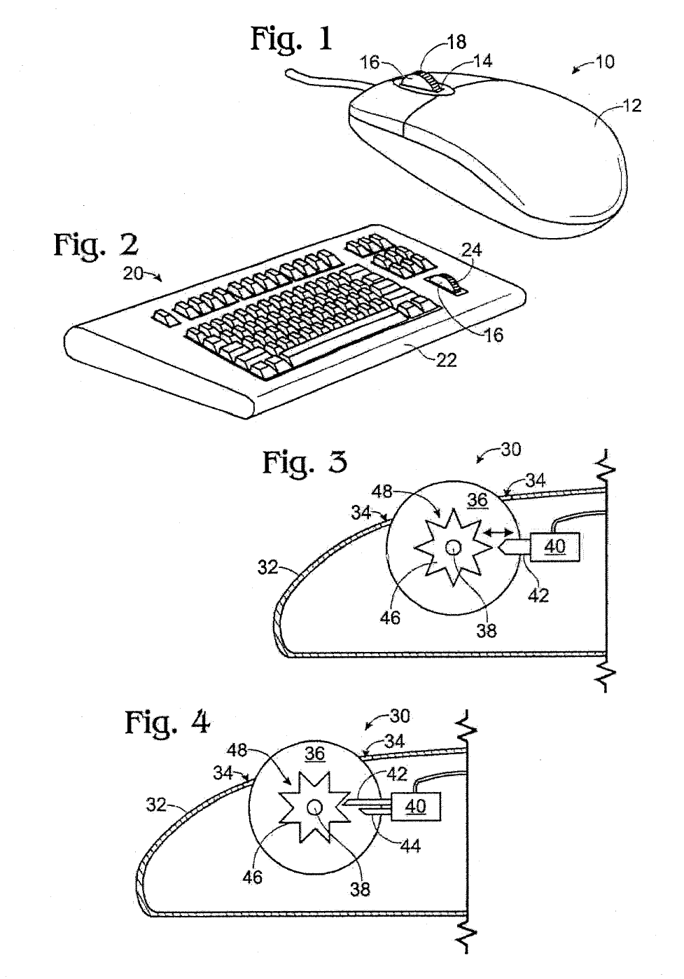

FIG. 4 diagrams solenoid 40 in an active state, limiting rotatability of the control wheel 36 by extending a pin 42 from the body of the solenoid 40. Actuation of the solenoid 40 causes the pin 42 to be inserted into a sprocket void 48 of a sprocket 46 coupled to the scroll wheel 36. Alternatively, the solenoid pin 42 can be configured to drag against nubs formed on the control wheel.

In preferred embodiments, the control wheel limiter, such as the solenoid 40, is structured to limit rotatability of the control wheel in a first direction while not limiting rotatability of the control wheel in a second direction. For example, a flexibly structured solenoid pin can be utilized, or a pair of solenoids can be employed wherein each solenoid is configured to limit control wheel rotation in only one direction.

The control wheel limiter can be structured to, in response to a first position signal, limit the control wheel from being rotated in a first rotational direction. In response to a second position signal, the control wheel limiter can limit the control wheel from being rotated in a second rotational direction. If both the first and second position signals are received, the control wheel limiter can limit the control wheel from being rotated in both the first and second directions.

Whether the control wheel limiter comprises one solenoid 40 (FIG. 3) or a pair of solenoids 40 (FIG. 4), each solenoid can be individually actuated. As is known, a solenoid is actuated by energizing an internal electromagnet by an electrical signal. In the embodiment of FIG. 4, each solenoid 40 is structured to, when actuated, cause a flexible solenoid pin (42,44) to be inserted into a sprocket void 48 of a sprocket 46 coupled to the control wheel 36. The flexible solenoid pin 42,44 can limit rotation of the control wheel in one direction, while flexing to not limit control wheel rotation in the other direction.

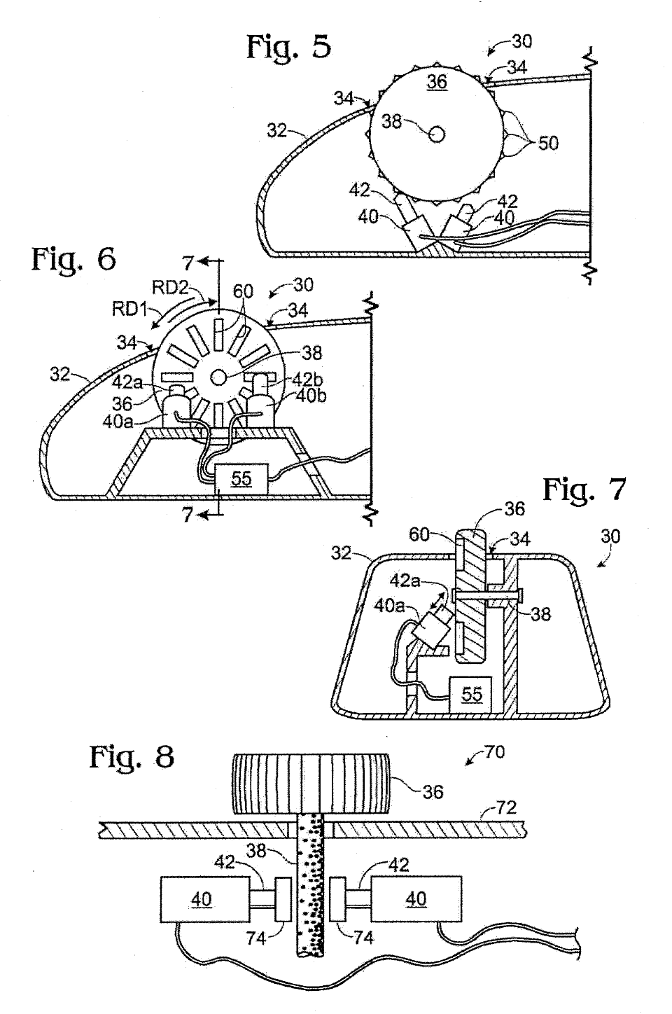

In another alternative embodiment shown in FIG. 5, the control wheel limiter limits rotatability of the control wheel 36 by mechanically engaging nubs or knurls 50 on the control wheel. As shown, each solenoid 40 is mounted adjacent the control wheel. In this manner, an individual solenoid 40 can be actuated to limit control wheel 36 rotatability in one direction while still permitting rotation in the opposite direction.

In still another alternative embodiment shown in FIGS. 6-7, the control wheel limiter comprises first and second solenoids 40A, 40B, each of which is structured to uni-directionally limit rotatability of the control wheel 36. The first solenoid 40A is configured to, in response to a first position signal, substantially limit rotatability of the control wheel 36 in the first direction by mechanically engaging the control wheel. The second solenoid 40B is configured to, in response to a second position signal, substantially limit rotatability of the control wheel 36 in the second direction by mechanically engaging the control wheel.

Configured as shown in FIGS. 6-7, solenoids 40A,40B extend or swing solenoid pins 42A,42B when actuated. Solenoid pins 42A,42B are structured to engage slots, detents or projections 60 in the control wheel 36. FIG. 7 shows a side view illustrating how the pin 42 is extended or placed at an angle to engage the control wheel 36. A first solenoid 40A is actuated and first solenoid pin 42A is extended or placed to limit the control wheel in rotational direction RD 1 while permitting rotation in rotational direction RD2. Actuation of second solenoid 40B, and extension or placement of second solenoid pin 42B, will likewise engage a slot, detent or projection 60 on the control wheel 36 to limit the control wheel in rotational direction RD2 while permitting rotation in rotational direction RD1.

FIG. 8 is a cross-sectional side view of an alternative embodiment input device, such as a keyboard 70, incorporating a knob-like control wheel 36. The control wheel 36 is mounted on the device 70 having a panel face 72. In this embodiment, a pair of solenoids 40 are opposingly mounted within the frame 72 of the device 70. When actuated, the solenoids 40 extend respective solenoid pins 42 which contact the control wheel axle 38 to limit rotatability of the knob.

Unidirectional rotational limitation can be achieved in this embodiment by, for example, mounting solenoids 40 at angles to the axle 38 shaft (similar to the configuration shown in FIG. 5) and distributing ridges or knurls on the axle shaft. The solenoid pins 42, when extended by an actuated solenoid 40, engage the axle shaft surface (whether smooth, ridged, knurled or otherwise textured), providing drag to limit rotation of the control wheel 36.

In other embodiments, the degree of mechanical engagement of the solenoid pins 42 with the axle 38 can be controlled by including solenoid pin feet 74 on the ends of the pins. The composition of such feet 74 can be manipulated (e.g., rubber or silicone) to produce a range of devices having different degrees of rotational limitation.

The control wheel 36, as presented herein, can aid in a user viewing an electronic document (e.g., a word-processing document or a web page) in a viewing window of a host computer device when using a software application. Such applications, or application program interfaces (APIs), generally monitor the displayed portion of an electronic document relative to the document as a whole. The software is operative to detect the placement of the portion of the shown document relative to the whole, and assigns a corresponding scroll value. Two important scroll values are when the top of the document is at the top of the viewing window (document up) and when the bottom of the document is at the bottom of the viewing window (document bottom). When the displayed document fully fit within the viewing window, both document top and document bottom are asserted.

The control wheel 36 exploits the scroll values resident in the application or API. Generally, a TOP scroll value in a document that is displayed on the host device can be corresponded with the first position signal, and a BOTTOM scroll value with the second position signal. The present input device thereby can determine whether a document portion displayed in a viewing window represents the document top position, document bottom position, or a portion intermediate the document end positions. The input device 70 can further comprise a position signal receiver 55 (FIG. 6) operative to receive the position signal from the host device.

A method for providing tactile feedback to a user of an input device scroll wheel includes determining if a document displayed in a viewing window of a host device is at one of two end positions within the viewing window; and limiting rotation of the scroll wheel in at least a first direction if the document is at one of the end positions.

Limiting rotation of the control wheel 36 preferably comprises actuating a solenoid 40 to slidably engage the control wheel as described above. Actuating a solenoid 40 causes a solenoid pin 42 to be inserted into a sprocket void of a sprocket coupled to the control wheel 36 or otherwise mechanically engage the control wheel.

Determining if a document is at one of two end positions can be accomplished by determining if a document is at a document top position or a document bottom position, preferably by detecting a scroll value corresponding to a position of the document in the viewing window. The scroll values can be received from the software application or API associated with the document.

It is known in the art that, for a Microsoft® Windows® environment, several windows (applications) can be concurrently open, but only one of those windows has “focus”, i.e., only one of the application windows is responding to input from a mouse, keyboard, or other input device. It is further known that the software, API or operating system routinely performs a document position or scroll check, to aid in properly drawing and/or redrawing the slide bar for the window having focus.

When a user changes the window having focus (e.g., by mouse-clicking within that window or pressing Alt-Tab in Windows®) the document position check must be re-performed for the newly-activated window. Other operating systems, like X-Windows, dictate that the window where the cursor is pointing is the active window, without the need for clicking or keyboard strokes. In that system, the document position check must be performed as the pointer moves across a new window.

The present control wheel is intended to provide input signals and tactile feedback relating to the document in the active window. By “eavesdropping” on the system recheck of the document positions and scroll values, the control wheel can determine document position and selectably actuate the control wheel limiter to limit rotation of the wheel in a first direction, a second direction, or both directions.

A person skilled in the art will be able to practice the subject matter presented herein in view of the description in this document, which is to be taken as a whole. Numerous details have been set forth in order to provide a more thorough understanding, but, in other instances, well-known features have not been described in detail in order not to unnecessarily obscure the invention.

While the disclosure has presented preferred forms of a control wheel with tactile feedback, the specific embodiments thereof as disclosed and illustrated herein are not to be considered in a limiting sense. Indeed, it should be readily apparent to those skilled in the art in view of the present description that the disclosed embodiments can be modified in numerous ways. The applicants regard the inventive subject matter herein to include all combinations and sub-combinations of the various elements, features, functions and/or properties disclosed herein.

What is claimed is:

1. An input device structured to provide tactile feedback to a user of the input device, comprising:
a rotatable control wheel structured to provide an input signal to a host device; and
a control wheel limiter structured to, in response to a position signal from the host device, limit rotatability of the control wheel.

2. The input device of claim 1 wherein rotating the control wheel causes the host device to scroll a document within a display window.

3. The input device of claim 1 wherein the position signal indicates a scroll value for a document displayed on the host device.

4. The input device of claim 1 wherein the control wheel limiter comprises a solenoid.

5. The input device of claim 4 wherein the solenoid is configured to, in response to the position signal, substantially limit rotatability of the control wheel by mechanically engaging the control wheel.

6. The input device of claim 4 wherein the solenoid is configured to, in response to the position signal, drag against nubs formed on the control wheel.

7. The input device of claim 4 wherein the solenoid, when actuated, causes a solenoid pin to be inserted into a sprocket void of a sprocket coupled to the scroll wheel.

8. The input device of claim 1 wherein the control wheel limiter is structured to, in response to a first position signal, limit the control wheel from being rotated in a first rotational direction.

9. The input device of claim 8 wherein the control wheel limiter is structured to, in response to a second position signal, limit the control wheel from being rotated in a second rotational direction.

10. The input device of claim 9 wherein the first position signal corresponds to a TOP scroll value in a document that is displayed on the host device, and wherein the second position signal corresponds to a BOTTOM scroll value in the displayed document.

11. The input device of claim 1 wherein the control wheel limiter is structured to limit rotatability of the control wheel in a first direction while not limiting rotatability of the control wheel in a second direction.

12. The input device of claim 11 wherein the control wheel limiter comprises first and second solenoids each structured to uni-directionally limit rotatability of the control wheel, and wherein said first solenoid is configured to, in response to a first position signal, substantially limit rotatability of the control wheel in the first direction by mechanically engaging the control wheel and said second solenoid is configured to, in response to a second position signal, substantially limit rotatability of the control wheel in the second direction by mechanically engaging the control wheel.

13. The input device of claim 12 wherein the first solenoid is structured to, when actuated, cause a first solenoid pin to be inserted into a sprocket void of a sprocket coupled to the scroll wheel and the second solenoid is structured to, when actuated, cause a second solenoid pin to be inserted into the sprocket void of the sprocket.

14. The input device of claim 1 further comprising a position signal receiver operative to receive the position signal.

15. An input device structured to provide tactile feedback to a user of the input device, comprising:
an input device frame having a frame aperture;
a rotatable control wheel structured to provide an input signal to a host device, the control wheel mounted to the device frame and protruding sufficiently through the frame aperture to allow it to be rotated by such user;
a position signal receiver operative to receive a position signal corresponding to a scroll value in a document displayed on the host device; and
a control wheel limiter structured to, in response to a received position signal, limit rotatability of the control wheel.

16. The input device of claim 15 wherein rotating the control wheel causes the host device to scroll the document within a display window on the host device.

17. The input device of claim 15 wherein the control wheel limiter is structured to, in response to a first position signal, limit rotatability of the control wheel in a first rotational direction, and wherein the control wheel limiter is structured to, in response to a second position signal, limit rotatability of the control wheel in a second rotational direction.

18. The input device of claim 17 wherein the control wheel limiter is structured to limit rotatability of the control wheel in the first direction while permitting rotatability of the control wheel in the second rotational direction.

19. The input device of claim 17 wherein the first position signal corresponds to a TOP scroll value and the second position signal corresponds to a BOTTOM scroll value.

20. The input device of claim 15 wherein the control wheel limiter comprises a solenoid.

21. The input device of claim 20 wherein the solenoid is configured to, in response to a position signal, substantially limit rotatability of the control wheel by mechanically engaging the control wheel when the solenoid is actuated.

22. The input device of claim 20 wherein the solenoid is configured to, in response to a position signal, drag against nubs formed on the control wheel.

23. A method for providing tactile feedback to a user of an input device scroll wheel, comprising:
determining if a document displayed in a viewing window of a host device is at one of two end positions within the viewing window; and
limiting rotation of the scroll wheel in at least a first direction if the document is at one of the end positions.

24. The method of claim 23 wherein limiting rotation of the scroll wheel comprises actuating a solenoid to slidably engage the scroll wheel.

25. The method of claim 24 wherein actuating a solenoid causes a solenoid pin to be inserted into a void of a sprocket on the scroll wheel.

26. The method of claim 23 wherein determining if a document is at one of two end positions comprises determining if a document is at a document top position or a document bottom position.

27. The method of claim 23 wherein determining if a document is at one of two end positions comprises detecting a scroll value corresponding to a position of the document in the viewing window.

28. The method of claim 23 wherein the first direction is a direction the scroll wheel can be rotated for downward scrolling of the document in the viewing window.

29. The method of claim 23 wherein limiting rotation of the scroll wheel comprises actuating a scroll wheel limiter when the scroll value corresponds to either of a document top position or a document bottom position.

30. The method of claim 23 wherein limiting rotation of the scroll wheel in at least a first direction comprises limiting rotatability of the control wheel in the first direction while permitting rotatability of the control wheel in a second direction.
